(19) United States
(12) Patent Application Publication
(10) Pub. No.: US 2016/0212404 A1
(43) Pub. Date: Jul. 21, 2016

(54) Prevention and Treatment of Myopia

(71) Applicant: THE SCHEPENS EYE RESEARCH INSTITUTE, INC., Boston, MA (US)

(72) Inventors: Guido Maiello, Boston, MA (US); Peter Bex, Boston, MA (US); Fuensanta A. Vera-Diaz, Boston, MA (US)

(21) Appl. No.: 14/913,586

(22) PCT Filed: Aug. 22, 2014
(86) PCT No.: PCT/US14/52398

§ 371 Date: Feb. 22, 2016

Related U.S. Application Data
(60) Provisional application No. 61/869,630, filed on Aug. 23, 2013.

(51) Int. Cl. H04N 13/00; H04N 13/04

(52) U.S. Cl. CPC H04N 13/0033; H04N 13/0022; H04N 13/0484

(57) ABSTRACT

Methods and apparatuses for preventing myopia, treating myopia, and/or preventing the progression of myopia are disclosed. The method includes controlling at least one of stimulus to accommodation, image blur distribution, and scene binocular disparity presented to the observer, and selecting an image based on the controlling. The method may be implemented in a display such as a computer display, a cellphone display, a video game display, or a television display.

### CROSS REFERENCE TO RELATED APPLICATIONS

The current application claims priority under 35 U.S.C. §119(e) to U.S. Provisional Patent Application No. 61/869,630 filed on Aug. 23, 2013, entitled “Prevention of Myopia,” the contents of which are incorporated herein by reference in their entirety for all purposes.

### STATEMENT OF GOVERNMENT SPONSORED SUPPORT

This invention was made with government support under grant numbers R01 EY018664 awarded by the National Eye Institute. The government has certain rights in the invention.

### TECHNICAL FIELD

The subject matter described herein relates to the prevention of myopia development, and to the treatment of myopia and myopia progression.

### BACKGROUND

Interventions to clinically manage myopia (commonly referred to as nearsightedness) include eyeglasses, contact lenses, and refractive surgery. All of these interventions optically compensate for myopic refractive error, but none of them prevent myopia development, treat myopia, or affect the progression of myopia.

Myopia is a major public health concern, due in part to its rapidly increasing prevalence over the past half-century. The high prevalence of myopia, considered an epidemic in certain areas of the world, has at least three effects: increased risk of visual impairment and blindness in the general population; decreased quality of life for those individuals affected; and a heavy economic burden. The World Health Organization (WHO) recognizes that myopia is a major cause of visual impairment, and constitutes a significant risk for potentially blinding ocular diseases, including (but not limited to) cataracts, glaucoma and retinal detachment. The risk for these diseases may not be decreased by the types of correction currently available for myopia. The most recent report published by the WHO on the cost of correcting vision impairment from uncorrected refractive error claims US$202 billion in estimated loss of global gross domestic product. For these reasons, preventing myopia and the progression of myopia is an increasingly important public health concern.

### SUMMARY

Methods and apparatuses for preventing myopia, treating myopia, and treating the progression of myopia are disclosed. A method may be provided which includes controlling at least one of the following factors: stimulus to accommodation, image blur distribution, and scene binocular disparity. An image may be selected based on the controlling.

In some variations, one or more of the features disclosed herein including the following features can optionally be included in any feasible combination. The method may be implemented in a display such as a computer display, a video game display, or a television display. The stimulus to accommodation presented to an observer may be controlled by a switchable lens system synchronized to the display, or by adjusting the relative intensity of image planes set to different focal distances. The blur distribution of the image may be controlled by a processor that renders an image in accordance with a 3-D gaze position of the observer. The scene's binocular disparity may be controlled by a processor that renders two separate images in accordance with the distance between the eyes of the observer; the two separate images may be presented to the observer through stereo glasses (or any stereoscopic display methodology) that provide each eye with the correct image.

### BRIEF DESCRIPTION OF THE DRAWINGS

FIG. 1A depicts an example of differences in the ability of emmetropes and myopes to discriminate blurred patterns in the peripheral visual field, in accordance with some example implementations;

FIG. 1B depicts an example of differences in the accommodative response of emmetropes and myopes to depth cues from stimuli, in accordance with some example implementations;

FIG. 2 depicts an example of a process for preventing or treating myopia and/or the progression of myopia by controlling an accommodation feedback loop, an amount of dioptric blur at the retinal level, and/or an amount of binocular disparity, in accordance with some example implementations;

FIG. 3 depicts an example image showing a normal distribution of blur across an image, in accordance with some example implementations;

FIG. 4 depicts an example of a process for preventing or treating myopia and/or the progression of myopia that may be performed in a display device, in accordance with some example implementations;

FIG. 5 depicts an example of a device to control stimuli to accommodation, in accordance with some example implementations; and

FIG. 6 depicts another example of a device to control stimuli to accommodation, in accordance with some example implementations.

### DETAILED DESCRIPTION

Prevention and treatment of myopia relies in part on understanding what factors affect the development of myopia. Myopia may result from a failure of emmetropization, a visually guided process that uses visual feedback to regulate eye growth and consequently refractive error of the eye. Emmetropization may require detection of blur with feedback from higher visual levels. Animal and human studies may demonstrate that continuous blur is a signal for disruption of emmetropization which may lead to excessive eye growth and myopia development. In addition, peripheral blur may be sufficient to induce myopia, even with clear central vision. A balance between central and peripheral blur responses may be critical for normal emmetropization. Conventional optical correction of myopia for central vision may cause over-correction of peripheral vision, consequently inducing a constant blur signal.

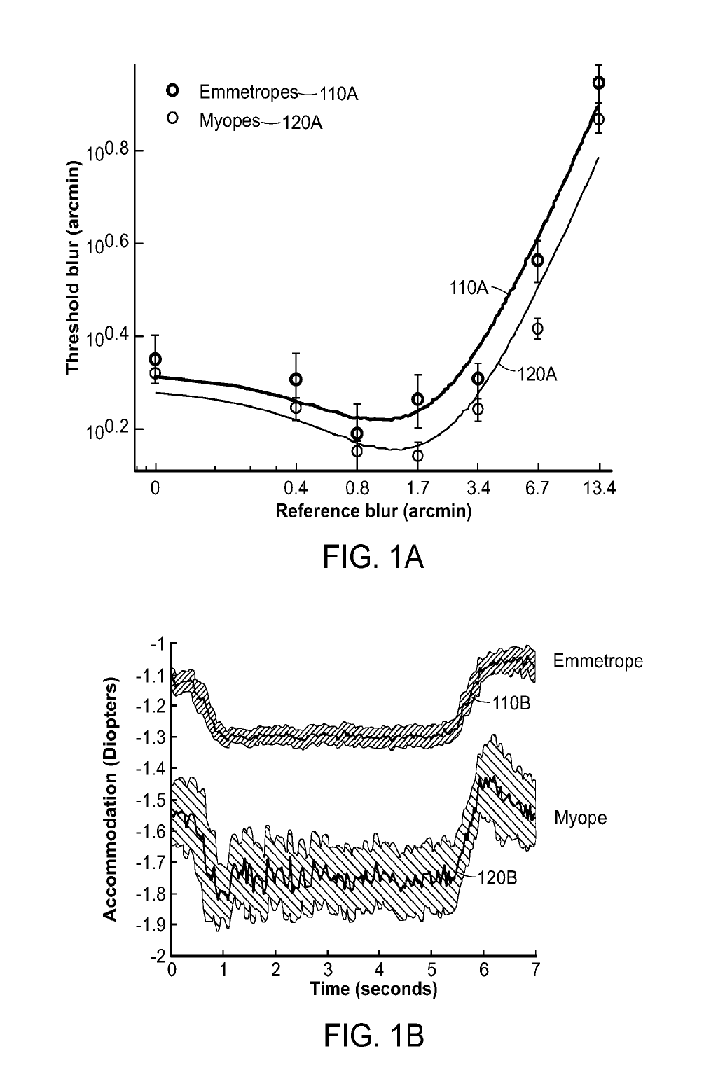

One possible cause for continuous blur is decreased sensitivity to blur, i.e., an impaired ability to recognize blur, in susceptible individuals. FIG. 1A shows differences in sensitivity to blur between myopes 120A and emmetropes 110A (emmetropes have normally refractive eyes not needing correction). Impaired ability to recognize blur may cause exposure to longer periods of blur because the impaired ability prevents compensation for the blur. In addition, time spent outdoors may be protective against myopia development. A difference between the nature of images in outdoor environments compared to indoor environments is the distribution of relative depths and blur. Myopes, or future myopes, may have a decreased ability to adequately change focus (accommodate) for different viewing distances.

FIG. 1B shows differences between emmetropes 110B and myopes 120B in accommodation response to peripheral blur stimuli. Future myopes may need additional cues for adequate accommodation such as when a holographic display is used. In some example implementations, 3-D stimuli to control the various cues to accommodation (depth, size, central and peripheral blur) may be presented when evaluating and/or determining blur detection and accommodation of an observer. In some example implementations, the 3-D stimuli may be presented indoors.

An environmental risk factor for developing myopia may be near work, including reading, writing, working with computer monitors, videogame play, and the like. When using media devices, people spend substantially long periods accommodating to only one focal distance, such as a distance to a TV screen, a computer monitor, a cellphone display, a book, and the like.

In some example implementations, one or more of the above-described factors may be controlled to prevent myopia. As used herein, treating myopia includes preventing the onset, preventing progression, and reducing the rate of progression of myopia. Specifically, accommodation stimuli, distribution of image blur across the peripheral visual field (also referred to as dioptric blur), and/or the scene binocular disparity may be controlled, in some example embodiments, to treat myopia. The first factor, accommodation stimuli, refers to the stimuli for the eye to adjust its refractive power to a particular focal distance. Frequent changes in accommodation to objects located at different focal distances, or depths, may prevent myopia. The second factor, distribution of image blur, refers to the particular distribution and progression of blur levels across the peripheral retina. The third factor, binocular disparity, is the difference in an image when viewed by cameras (or, for example, eyes) spaced apart at a certain distance. Controlling one or more of these three factors may, prevent myopia and/or prevent the progression of myopia. In addition to treating/preventing myopia, the apparatuses and methods disclosed herein may be used to treat/prevent other conditions of the eye as well.

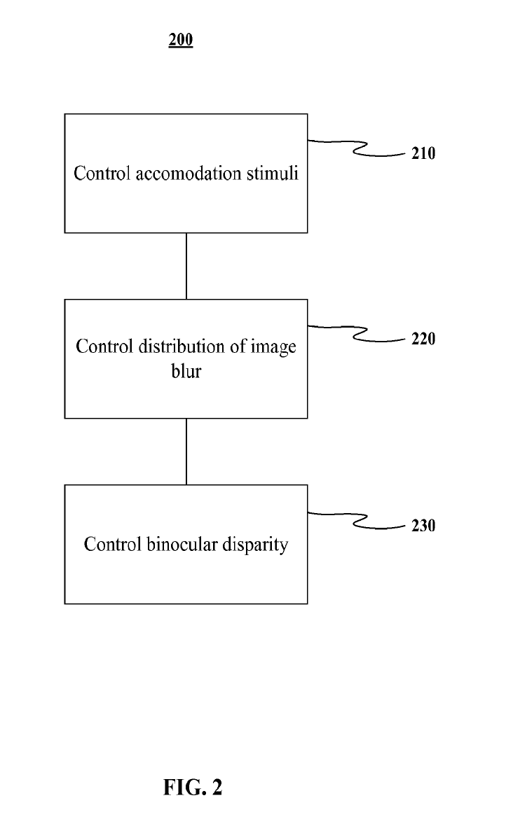

FIG. 2 depicts an example of a process 200 for preventing myopia and/or the progression of myopia by controlling accommodation, dioptric blur, and/or binocular disparity. In some example implementations, the process 200 may be implemented in a display, such as a monitor used to present information for a computer, a video game, a cellular telephone/smartphone, a tablet computer, a netbook, a heads-up display, and/or the like.

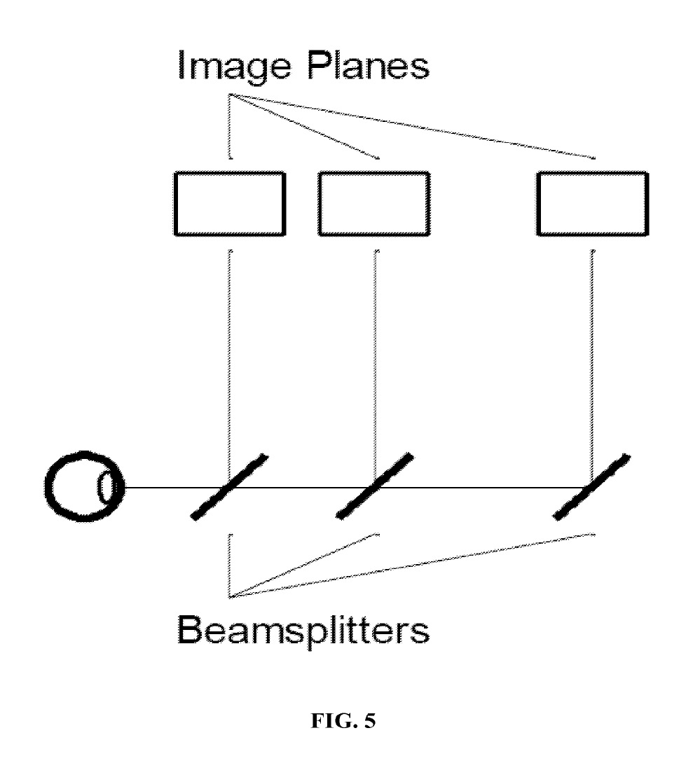

At 210, the stimuli to accommodation may be controlled, in accordance with some example implementations. In some example implementations, accommodation responses may be controlled by a display that presents multiple image planes (depths) to a viewer. For example, multiple image planes at different focal distances may be combined and displayed to a viewer to control accommodation responses. An example device consistent with some implementations is further described with respect to FIG. 5. Accommodation may be controlled by adjusting the relative intensity of the various image planes. For example, a heavy weighting to an image plane set to a long distance combined with a much lighter weighting to another image plane set to a short distance results in a composite image that appears to be at a distance much closer to the image plane set to the long distance than the image plane set to the short distance.

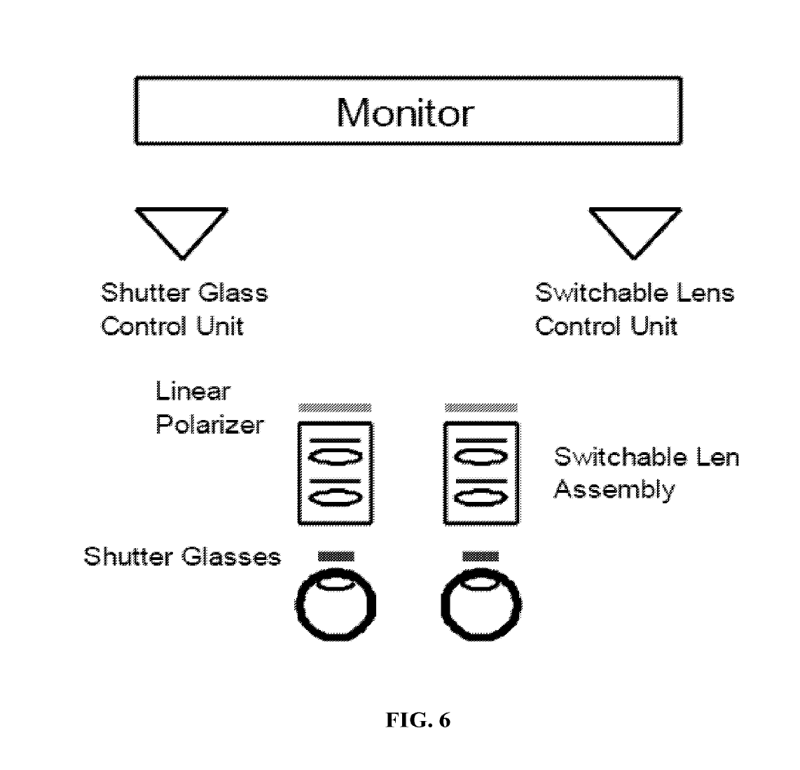

In some example implementations, stimuli to accommodation may also be controlled using a switchable lens system synchronized to the display. An example device consistent with some example implementations is further detailed with respect to FIG. 6, although other types of devices may be used as well. A switchable lens system may produce blur on the retina that drives an accommodation response by the observer. Multi-layer displays may drive variable accommodation responses of the observer to different depth layers. Near-eye light field displays may also drive accommodation response of the observer to different depth layers and change the distribution of blur across the retina.

At 220, image blur, such as dioptric blur, may be controlled, in accordance with some example implementations. Dioptric blur describes the image degradation that arises from a mismatch between the focal length of a lens and the distance to the object. Other forms of blur include aperture blur, which may vary with pupil diameter and is described by a sinc function. Gaussian blur and diffusive blur may arise from light scatter from degraded optics such as cataracts. Motion blur may arise from movement during image capture. Other optical aberrations may arise from imperfections in anterior optics of the observer's eyes. In some example implementations, the distribution of blur levels across the visual field may be controlled to simulate the distribution of blur which occurs in natural, uncontrolled environments, such as outdoor environments. In a typical outdoor environment, an observer may see (or perceive) part of a scene (or an image within a scene) as sharp and clear. The center of this part of the image is referred to as a fixation point. The remainder of the image may be out of focus (for example, blurred) by varying degrees depending on the spatial arrangement of the objects in the image. For example, objects that are farther away than the object at the fixation point tend to be more out of focus the farther away they are. Objects in the image that a closer than the in-focus object also tend to be more out of focus the closer they are to the viewer. However, the viewer may not necessarily be aware of the blur due to perceptual constancy effects.

In some example implementations, the amount and type of blur may be controlled digitally, at 220, by executable instructions performed at a processor. For example, images may be generated by a computer application, such as a word processor or a video game and the like, that may be displayed with a distribution of blur controlled at 220 as noted above.

In some example implementations, a digital camera, such as a light field camera, plenoptic camera, and/or the like, may be used to capture multiple versions of an image. The multiple versions of the image are sometimes referred to as an image stack where each version is an individual image within the image stack. Each version of the image may be focused at a different focal distance. Objects in each version of the image that are at, or near the focal distance will appear in-focus and objects that are at distances farther or closer than the focal distance will appear out of focus. Associated with the image stack is a look-up table relating the images in the image stack to their associated focal distances. To display these images for an observer, an eye tracker may be used to monitor the fixation point of the observer's eye. The amount of dioptric blur adequate for each point in the image may be adjusted in real-time based on the position of the observer's eye(s) determined by the eye tracker, and the image stack. For example, when the observer's eyes change fixation points, a different image from the image stack may be selected based on the focal distance in the image at the new fixation point. For computer-generated graphics, the dioptric blur may be predetermined or calculated.

For computer-generated graphics, the depth of the image may be known a priori since the image focal distance is created, when the image is designed or programmed. For example, a developer of a computer game and its graphics may control during development the depth of the graphics presented to a viewing game player.

At 230, the binocular disparity of the scene viewed by the observer may be controlled, in accordance with some example implementations. Binocular disparity refers to the difference in viewing angle of the images presented to each eye due to the separation in distance of the two cameras that recorded the images. For example, eye separation produces binocular disparity (also referred to as parallax) due to the distance between the eyes. Binocular disparity may be used to extract depth information from two-dimensional images.

In some example implementations, an eye tracker may be used to determine the direction in which each of the observer's eyes is looking (e.g., the fixation point). Based on the observer's fixation point in an image, a processor may determine the focal distance for the image at that fixation point and the relative depth of other points in the image. In some implementations, a switchable shutter is used for each eye using, for example, stereoscopic shutter glasses. The switchable shutter may facilitate providing the viewer's eyes with different images. For example, one image may be presented to the left eye when a left shutter is open and a right shutter is closed. A different image may be presented to the right eye when the left shutter is closed and the right shutter is open. This may provide the observer's eyes with accurate binocular disparity that gives the perception of depth in an otherwise flat display. In some implementations, polarization, anaglyphs, lenticular screens, multi-layer glassless, 3-D tensor displays, and mirror stereograms may be used.

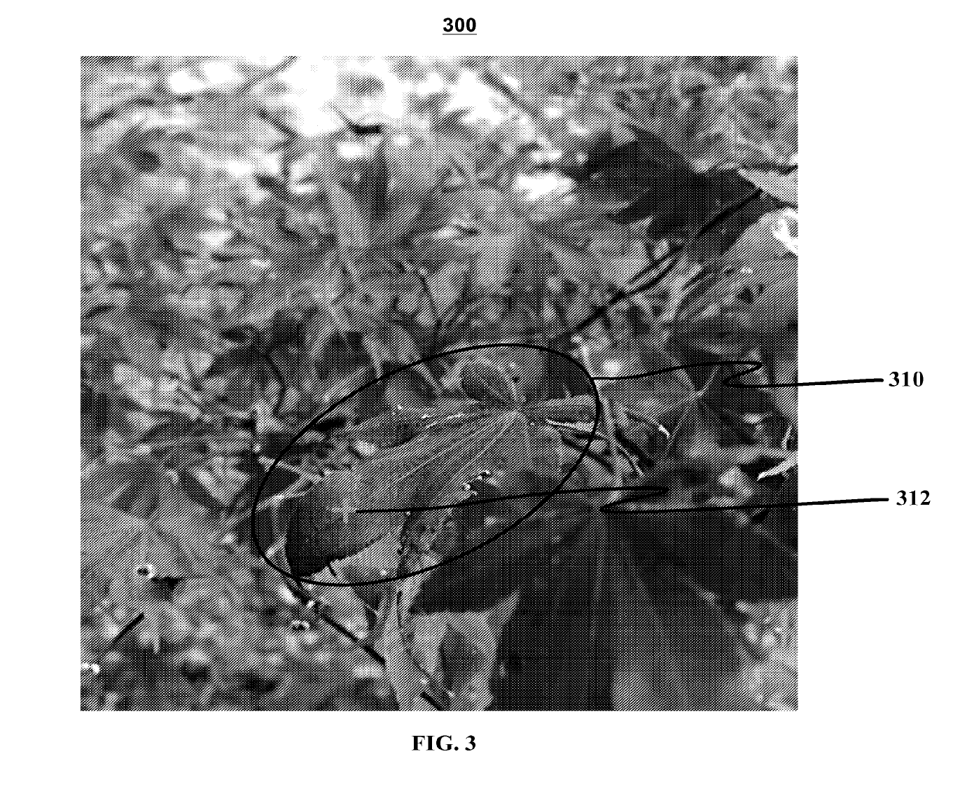

FIG. 3 depicts an example image showing a distribution of blur levels across the image, in accordance with some example implementations. The example image shown in FIG. 3 was constructed from a stack of light field images from a camera, such as a plenoptic camera, although other types of cameras may be used as well. A region in the center of the observer's visual field is shown at 310 as in-focus. The fixation point 312 in this example is marked by a plus sign, “+.” The image 300 also shows in-focus areas that do not fall in the center of the observer's visual field but that have the same focal distance as the fixation point. Other areas in the image 300 include objects at different focal distances than the fixation point 312 and therefore have some level of blur. Dioptric blur varies with the difference in focal distance from the fixated object. Objects in the image 300 that are closer to, or further from, the viewer may be dioptrically blurred, creating a distribution of blur across the retina. The level of blur may be proportional to the difference in focal distance between the fixation point and the blurred object.

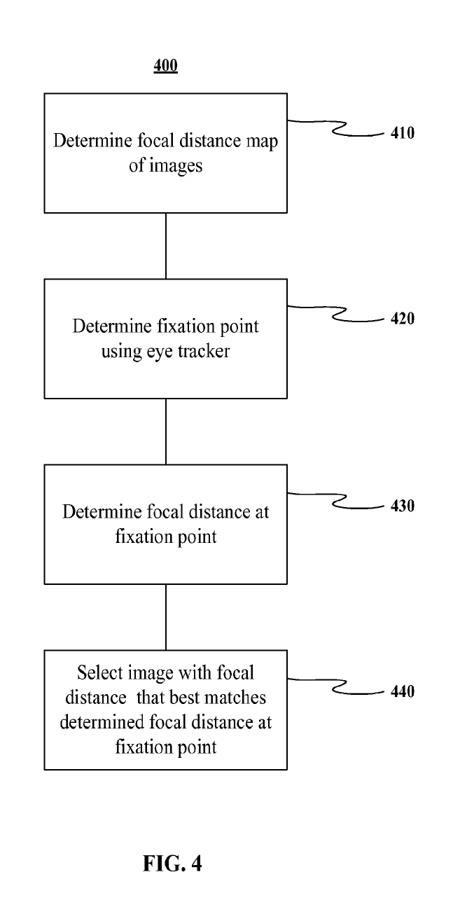

FIG. 4 depicts an example of a process 400 for preventing myopia and/or preventing the progression of myopia that may be performed in a display device, in accordance with some example implementations. The process 400 may be performed in any type of display.

At 410, a map (e.g., look-up table) associating the various images and their focal distances may be determined, in accordance with some example implementations. For example, a processor-based device may determine the focal distances of the images in an image stack. In some example implementations, the images may be taken by a camera, such as a plenoptic camera and/or any other digital camera. Each image in the stack may be focused at a different focal distance, one distance for each image in the stack. In some implementations, such as, for example, computer-generated images, an image stack may not be necessary because executable instructions performed by a processor in the computer may calculate and image with any needed focal distance.

At 420, the fixation point or gaze position of an observer's eye may be determined using an eye tracking device, in accordance with some example implementations. For example, the fixation point may be determined as a pixel coordinate position on a screen or image being viewed on a display.

At 430, the focal distance at the observer's fixation point based on the fixation point and the image may be determined, in accordance with some example implementations. For example, based on the fixation point determined in 420, the image's focal distance to the fixation point may be determined.

At 440, an image may be selected for presentation to the viewer that best matches the determined focal distance at the fixation point, in accordance with some example implementations. An image is selected from a stack of images based on the focal distance of the images in the stack. For example, a processor-based device may select the image in the image stack by choosing the image that has a corresponding focal distance that most closely matches the focal distance determined at 430. The image that most closely matches the determined focal distance may be the image in the stack that is most in-focus at the fixation point. In this way, an image that is in-focus at the center of the viewer's visual field (or at the fixation point) is selected. Objects in the image that have the same focal distance as the fixation point will also be in-focus, while everything else in the image may have varying levels of blur, in accordance with their distance from the fixation point. The selected image may, in some example implementations, be presented through a switchable lens system (e.g., shutter lenses).

FIG. 5 depicts an example of a device to control accommodation responses, in accordance with some example implementations. Each image plane shown in FIG. 5 may be presented through a different beamsplitter. The image planes may be combined so that the observer's eyes see the sum of the multiple image planes. Accommodation responses may be driven this way by adjusting the relative intensity of the image planes. For example, a heavy weighting to an image plane set to a large distance, and a much lighter weighting to another image plane set to a short distance results in a composite image distance much closer to the image plane at the large distance than the image plane at the short distance. In this way, it is possible to drive accommodation to arbitrary depth planes. The device at FIG. 5 may be under the control of a processor.

FIG. 6 depicts another example of a device to control accommodation responses, in accordance with some example implementations. In some example implementations, accommodation may be controlled with a switchable lens system synchronized to a display. A switchable lens system consistent with some implementations changes the stimulus to accommodation for the observer's eye by producing blur on the retina that drives changes in accommodation responses. The switchable lens system may include stereoscopic shutters (e.g., a shutter for each eye). For example, the stereoscopic shutters may include between each eye and the display, an optical system comprising linear polarizers, birefringent lenses each with their own liquid-crystal polarization switch, and shutter glass to provide stereoscopic image presentation. The device described at FIG. 6 may be under the control of a processor. The lens system is synchronized to the display to provide different images at different instances of the shutter being open.

One or more aspects or features of the subject matter described herein can be implemented in a processor. A processor may include digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented in a display device, such as for example a cathode ray tube (CRT), a liquid crystal display (LCD), a light emitting diode (LED) monitor, and/or any other type of display or monitor. A display may also be used by a computer for displaying information to the user. A computer may also include a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
controlling at least one of an accommodation stimuli, a distribution of image blur, and a binocular disparity; and
selecting an image based on the controlling.

2. The method of claim 1, wherein the method is implemented in a display including one or more of a computer display, a cellphone display, a video game display, and a television display.

3. The method of claim 1, wherein the accommodation stimuli is controlled by adjusting a relative intensity of image planes set to different focal distances.

4. The method of claim 1, wherein the distribution of image blur is controlled by at least one processor by producing an image corresponding to a fixation point of an viewer.

5. The method of claim 1, wherein the binocular disparity is controlled to provide each eye with a different image in accordance with a distance between the eyes.

6. An apparatus comprising:
at least one processor; and
at least one memory including computer program code, the at least one processor, the at least one memory, and the computer program code configured to cause the apparatus to at least:
control at least one of an accommodation stimuli, a distribution of image blur, and a binocular disparity; and
select an image based on the control.

7. The apparatus of claim 6, wherein the apparatus comprises one or more of a computer display, a video game display, and a television display.

8. The apparatus of claim 6, wherein the accommodation stimuli is controlled by adjusting a relative intensity of image planes set to different focal distances.

9. The apparatus of claim 6, wherein the distribution of image blur is controlled by the at least one processor by producing an image corresponding to a fixation point of a viewer.

10. The apparatus of claim 6, wherein the binocular disparity is controlled to provide each eye with a different image in accordance with a distance between the eyes.

11. A non-transitory computer-readable medium encoded with instructions that, when executed by at least one processor, cause operations comprising:
controlling at least one of an accommodation stimuli, a distribution of image blur, and a binocular disparity; and
selecting an image based on the controlling.

12. The non-transitory computer-readable medium of claim 11, wherein the at least one processor interfaces to a display including one or more of a computer display, a cellphone display, a video game display, and a television display.

13. The non-transitory computer-readable medium of claim 11, wherein the accommodation stimuli is controlled by adjusting a relative intensity of image planes set to different focal distances.

14. The non-transitory computer-readable medium of claim 11, wherein the distribution of image blur is controlled by the at least one processor by producing an image corresponding to a fixation point of a viewer.

15. The non-transitory computer-readable medium of claim 11, wherein the binocular disparity is controlled to provide each eye with a different image in accordance with a distance between the eyes.
